(19) United States
(12) Patent Application Publication
(10) Pub. No.: US 2024/0128901 A1
(43) Pub. Date: Apr. 18, 2024

(54) SINGLE CHIP ADVANCED ADAPTIVE SENSORLESS MOTOR SHAFT POSITION DETECTION

(71) Applicant: TEXAS INSTRUMENTS INCORPORATED, Dallas, TX (US)

(72) Inventors: Miroslav Oljaca, Allen, TX (US); David Stout, Chico, TX (US); Dennis P. Lehman, Garland, TX (US); Jan Morten Braathen, Redmond, WA (US); Merril Newman, Schaumburg, IL (US)

(21) Appl. No.: 17/965,519

(22) Filed: Oct. 13, 2022

(51) Int. Cl. H02P 6/10; H02P 6/182

(52) U.S. Cl. CPC H02P 6/10; H02P 6/182; H02P 21/18

(57) ABSTRACT

Methods, circuits and computer program products are presented herein. The method includes isolating a ripple waveform from a current signal originating from a brushed direct current motor (BDCM). The method includes determining the wave count of the ripple waveform. The method includes determining a position of a movable structure operably coupled to a shaft of the BDCM according to the wave count of the ripple waveform. The present technology may be practiced without discrete capacitor components in high pass filtering aspects of the disclosed circuit. The methods, circuits and computer program products can be implemented to accurately determine a rotational position of a shaft of a BDCM and also position(s) of mechanism(s) coupled to the shaft without requiring any external sensors or other components for this purpose other than the disclosed circuits.

### BACKGROUND

Brushed direct current motors (BDCMs) find applications in wide ranging fields. Their operation can be controlled with motor drivers or controllers using simple circuits and protocols. When the shaft of a BDCM is operably coupled (e.g., by gear(s), chain(s) and/or belt(s)) to a mechanism to be moved as a result of torque provided by the shaft, sensors positioned outside the BDCM may be necessary to determine the distance moved by the mechanism. Such external sensors take up space, add weight, consume power, and complicate the overall system that includes the BDCM and associated driver or controller.

### SUMMARY

An electronic circuit is presented herein. The electronic circuit may be embodied in an integrated circuit (IC). The electronic circuit includes at least one input port configured to receive input signals from outside of the electronic circuit. The input signals include a current signal originating from a brushed direct current motor (BDCM). The electronic circuit also includes logic circuitry operably coupled to the at least one input port. The logic circuitry is configured to isolate a ripple waveform from the current signal. The logic circuitry is also configured to determine a wave count of the ripple waveform. The logic circuitry is further configured to determine a position of a movable structure operably coupled to a shaft of the BDCM according to the wave count of the ripple waveform. The electronic circuit further includes at least one output port coupled to the logic circuitry and configured to transmit one or more output signals outside of the electronic circuit. The one or more output signals include data representative of the position of the movable structure determined by the logic circuitry.

Further, a method of operating an electronic circuit is presented. The electronic circuit for purposes of the method may be embodied in an IC. The method includes isolating a ripple waveform from a current signal originating from a BDCM. The method also includes determining the wave count of the ripple waveform. The method further includes determining a position of a movable structure operably coupled to a shaft of the BDCM according to the wave count of the ripple waveform.

Further, one or more non-transitory computer readable media is disclosed. The one or more non-transitory computer readable media may be embodied in a computer program product. The one or more non-transitory computer readable media have stored thereon program instructions, that, when executed by at least one processor, cause a machine to perform the method summarized above.

While multiple embodiments are disclosed, still other embodiments of the present technology will become apparent to those skilled in the art from the following detailed description, which shows and describes illustrative embodiments of the invention. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present technology will be described and explained through the use of the accompanying drawings in which:

FIG. 1 is a block diagram of a brushed direct current (DC) motor (BDCM) according to a known implementation;

FIG. 2 is a plot of commutator current for the BDCM shown in FIG. 1;

FIG. 3 is a plot of current flow for a BDCM as used in a mechanical device such as a BDCM-actuated bolt of a smart lock;

FIGS. 4A and 4B are additional plots of commutator current for a BDCM;

FIG. 5 shows a system including an integrated circuit (IC) according to an implementation;

FIGS. 6A-6C are plots of signal waveforms during operation of the IC shown in FIG. 5 according to an implementation;

FIGS. 7A-7D depict an operational sequence of a method for operating an IC according to an implementation; and

FIG. 8 is a functional view of a system suitable for implementing an implementation.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Known techniques for determining the position of a structure whose position is adjustable using a brushed direct current (DC) motor (e.g., a smart door lock) rely on sensors like encoders. Such sensors provide for accurate position determinations, but add additional components that take up space, require electric power, and increase complexity/costs of manufacture.

The present technology may be advantageously implemented without sensors in a single integrated circuit chip that amplifies and filters an incoming current signal from an energized brushed DC motor (BDCM) to isolate a ripple waveform representing the BDCM's commutation current. The wave count of the ripple waveform may be used in conjunction with the known number of poles of the BDCM to determine a position of a shaft of the BDCM, and thus also a position of a structure (e.g., smart lock bolt) operably coupled to the shaft.

The dynamic filtering scheme of the present technology utilizes adaptive bandpass filtering of the incoming motor current signal to isolate the ripple waveform. Adaptive filtering of the incoming motor current signal is also utilized to adjust low and high frequency cutoffs of the bandpass filter.

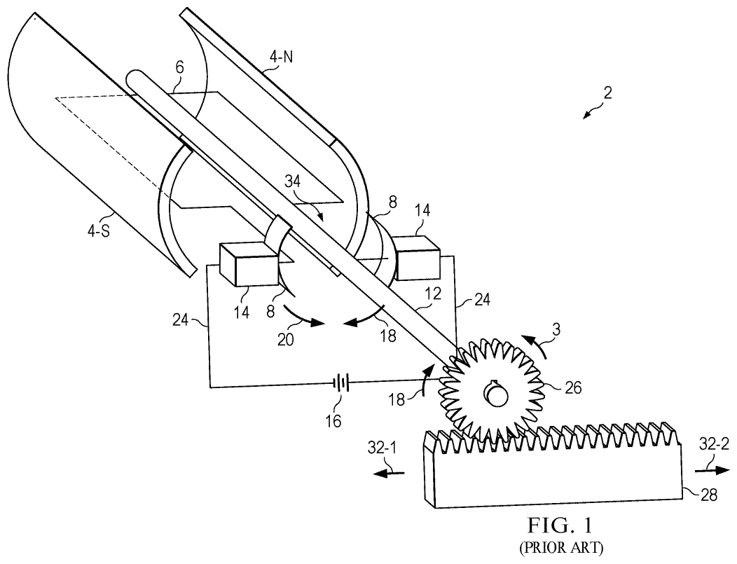

Referring now to the drawings, FIG. 1 shows a brushed DC motor (BDCM) 2 according to a known implementation. The known BDCM 2 includes a magnet assembly 4 having north (4-N) and south (4-S) poles. BDCM 2 includes a rotor coil 6 formed of a conductor like copper. A commutator assembly 8 is coupled to the rotor coil 6 and is also formed of a conductor (e.g., copper). The rotor coil 6 is both mechanically and electrically coupled to the commutator assembly 8 in BDCM 2. The BDCM 2 further includes a shaft 12 mechanically coupled to the rotor coil 6. As such, rotation of the rotor coil 6 carrying electric current applies a torque to thereby rotate the commutator assembly 8 and shaft 12 in the same direction.

In BDCM 2, the commutator assembly 8 makes contact with, but is not coupled to, brushes 14. The commutator assembly 8 slidably contacts the brushes 14 such that an electric current from a power supply 16 may pass through wire lines 24 through brushes 14 to commutator assembly 8 while rotor coil 6 rotates in a magnetic field induced between the north (4-N) and south (4-S) poles of the magnet assembly 4. As shown in FIG. 1, gaps 34 exist between portions of the commutator assembly 8, which reverses the direction of the current in the rotor coil 6 and enable continued rotation of the shaft 12 according to principals of operation of BDCMs 2 that are well known to persons having ordinary skill in the art. The BDCM 2 shown in FIG. 1 is a two-pole motor, but BDCMs may have additional poles in other known implementations (e.g., three-pole BDCMs).

The shaft 12 of BDCM 2 may be caused to rotate in either clockwise (CW) direction 18 or counterclockwise (CCW) direction 3 depending on the direction of current flow from power supply 16. Various structures, e.g., a gear 26, may be operably coupled to shaft 12. BDCMs 2 find numerous practical applications in various devices and systems. One use case for BDCM 2 is a rack and pinion style gearing arrangement. In such examples, rotation of gear 26 by shaft 12 in alternating CW direction 18 and CCW direction 3 causes linear motion of the toothed linear mechanism 28 in alternating directions (e.g., left 32-1 and right 32-2, respectively), as shown in FIG. 1. The example shown in FIG. 1 in this regard may be applied to devices and systems such as BDCM-actuated smart lock bolts.

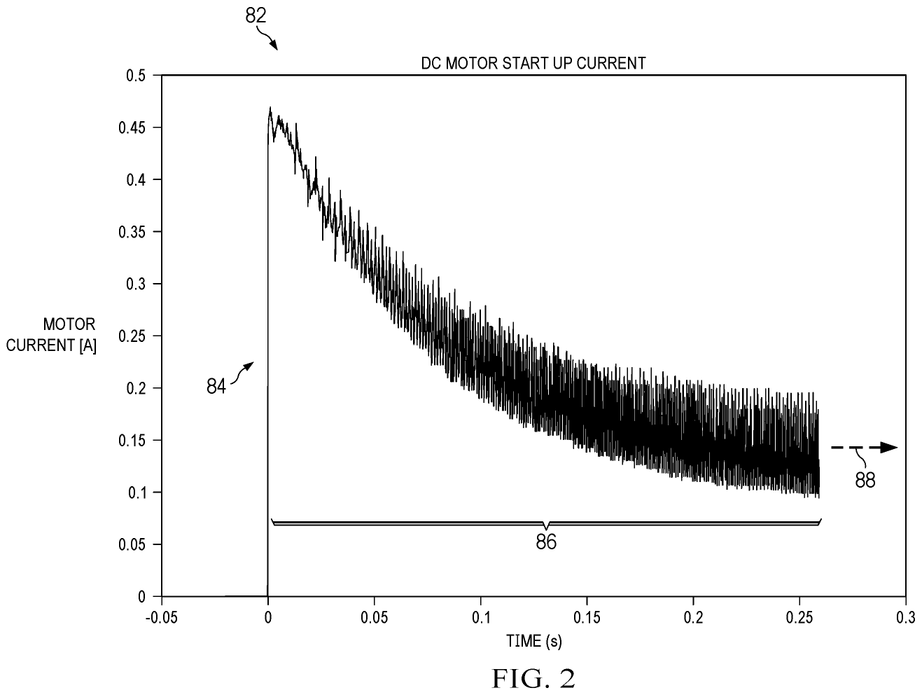

FIG. 2 is a plot 82 of current flow for the BDCM shown in FIG. 1. In plot 82, the x-axis is time in seconds (s) and the y-axis is the current (amps, A) from power supply 16. With further reference to FIG. 1, at time 0, current first begins to flow from power supply 16. This results in the initial current ramp, or step 84, from 0 A to approximately 0.46 A. From the step 84 current, the rotor coil 6 is energized and a magnetic force begins to act on rotor coil 6 causing it, commutator assembly 8, and shaft 12 to begin to rotate. Due to the presence of gaps 34 in the commutator assembly 8, a polarity of the current shown in plot 82 alternates as a sinusoidal alternating current (AC) waveform (“AC ripple”).

Assuming a constant mechanical load on shaft 12 along with a constant applied voltage from power supply 16, rotor coil 6 of BDCM 2 may experience an angular acceleration from rest in a start-up period 86. In the example of plot 82, the start-up period lasts for approximately 0.26 s. During the start-up period 86, the motor current decreases from approximately 0.46 A to approximately 0.15 A over the 0.26 s time frame. As can be seen from plot 82, the decrease in current in the start-up period 86 is an exponential decay. Furthermore, as the period of the AC ripple decreases from time 0 s to time 0.26 s in the start-up period 86. This reflects the frequency of the polarity reversal of the current in the brush 14, where lower rotational speeds of rotor coil 6 just after the step 84 cause brush 14 to pass the gaps 34 less frequently as compared to when rotor coil 6 is rotating faster at, for instance, time 0.26. As such, the frequency of the AC ripple is lower at earlier times in the start-up period 86 and increases exponentially toward the end of that period 86 of time. The magnitude of the AC ripple also changes in like manner during the start-up period, as shown in FIG. 2.

At the end of the start-up period 86, BDCM 2 enters a steady-state operation state 88 (after 0.26 s in the example shown in FIG. 2). Provided there are no perturbations in physical conditions associated with the steady-state 88, a frequency and magnitude of the AC ripple will remain at or near constant indefinitely in the steady-state of BDCM 2. The techniques according to the present technology take advantage of the above-described observable and measurable physical phenomena associated with operation of a bushed DC motor to derive useful information regarding physical mechanisms operably coupled to shaft 12. The techniques include counting the number of AC ripples occurring due to brush 14 passing gaps 34 in a defined time period to thereby determine the number of rotations of shaft 12 occurring during that time. Simple transformations of AC ripple counts may be applied to account for fixed known properties, such as a number of poles of BDCM 2. Determining such information directly by the present technology may then be applied to precisely compute linear and/or rotational positions of mechanisms operably coupled to the rotatable shaft 12 of BDCM 2.

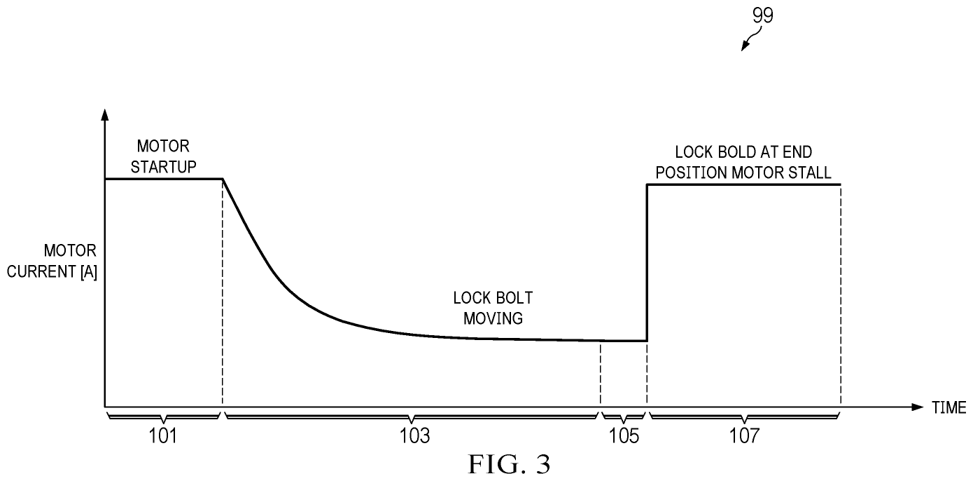

FIG. 3 is a plot 99 of current flow for a BDCM (e.g., as shown in FIG. 1) as used in a mechanical device such as a BDCM-actuated bolt of a smart lock. In plot 99, the initial motor startup current is applied starting at time 0 in a first time period 101 and can include the ramp as described above with reference to FIG. 2. A startup current waveform in the form of an exponential decay with AC ripples (not shown in FIG. 3) occurs in a time period 103. Depending on the distance the bolt needs to travel under torque by the BDCM, the motor may or may not achieve a steady state in a time period 105. In some examples of smart locks utilizing BDCMs, the motor will exert a torque on the bolt until a stall condition occurs, as where the bolt impacts a structure preventing its further travel (e.g., a locked bolt position). In plot 99, this occurs during a time period 107 which starts at the conclusion of time period 103, or time period 105 in cases where the BDCM does achieve a steady state of operation.

For the waveform shown in plot 99 of FIG. 3, a run time of the BDCM is based on a lowest voltage operation. This provides a long time in the stall position during time period 107 for the BDCM. In known BDCM applications like smart locks that do not utilize a current sensing capability to detect the stall condition, at a minimum a sensor or switch is needed to make sure the mechanism operably coupled to the shaft of the BDCM (e.g., smart lock bolt) is moving and not stuck. Such known approaches may reduce undue power consumption by use of the switch or sensor to detect bolt position while minimizing time spent by the BDCM in the stall condition. Other known BDCM applications may utilize current sensing to detect the stall condition at, for instance, a bolt end position to minimize time spent in time period 107 and thus also optimize power consumption by BDCM. Yet, some time is still spent by BDCM in a high current consuming state during stall since sensing the stall current (e.g., 430 mA) is necessary to detect the end position of the mechanism. The above discussion of plot 99 may be applicable to BDCM operation for causing a bolt of a smart lock, for example, to travel from an unlocked to a locked position and vice versa.

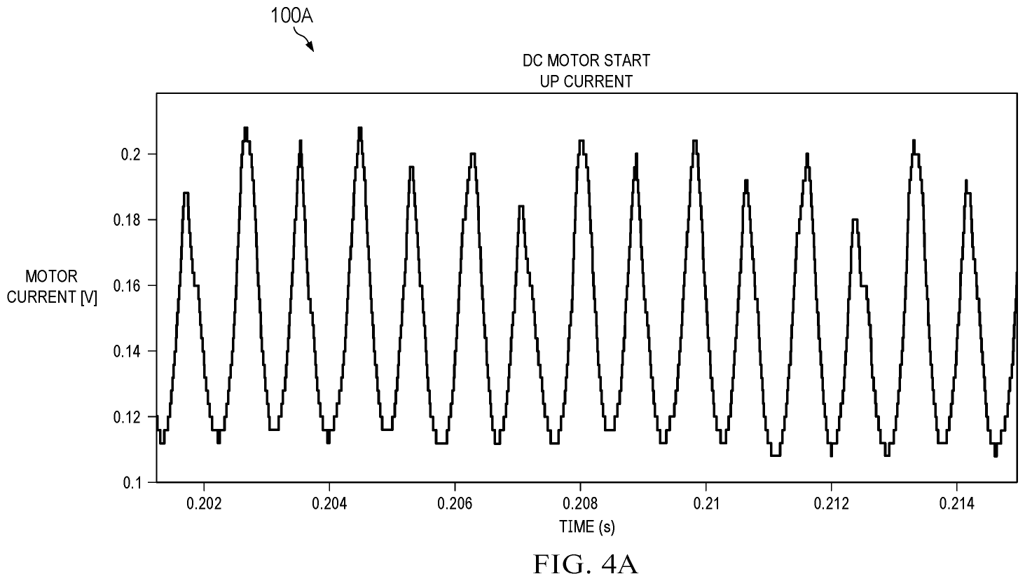

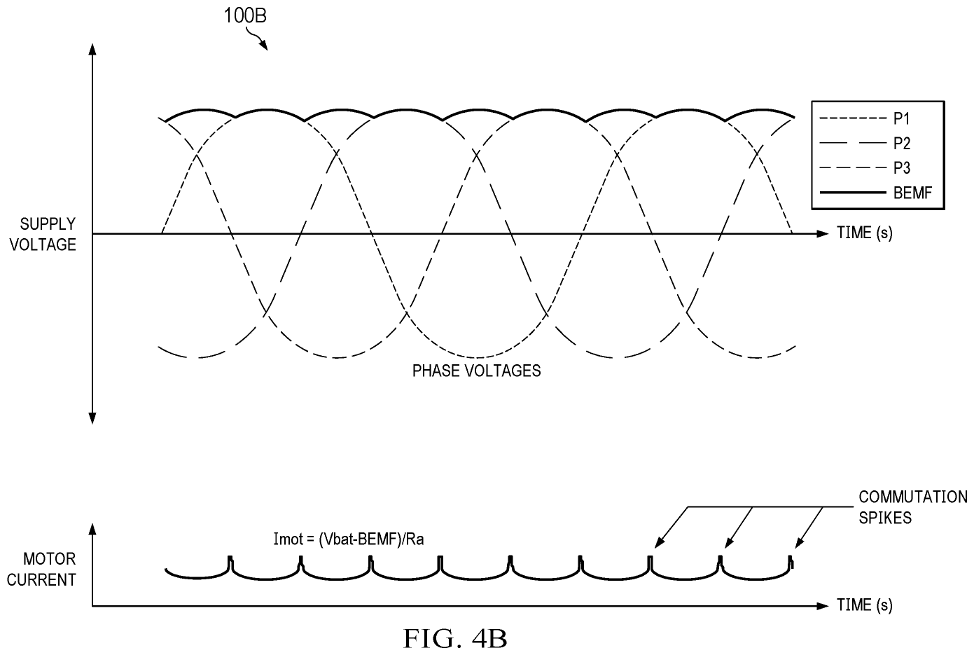

FIGS. 4A and 4B are additional plots 100A and 100B of commutation current for a BDCM. Plot 100A shows the AC ripple of the BDCM current in a duration of approximately 0.014 s representing the period 0.201 s to 0.215 s of the start-up period 86. Plot 100B shows waveforms for supply voltage and current for a BDCM having three poles (P1, P2, P3). BDCM brushes are what is responsible for reversing current to keep the BDCM shaft spinning when the supply voltage is being applied. As the shaft of the BDCM rotates, the poles run past the gaps between the brushes, and that reversal of current causes an AC ripple current as shown in plots 100A and 100B. The present technology utilizes this property of BDCMs to count the number of ripples of the AC ripple waveform in conjunction with fixed parameters like number of poles to determine the number of rotations of the shaft over a discrete time period. As shown in plot 100B, a three pole BDCM, the commutation ripple peaks, or spikes, correspond in time to troughs of a voltage waveform for electromotive force (back EMF, or “BEMF”) that opposes the change in current which induced it. As is known by persons of ordinary skill in the art, the principals of BDCM operation represented in plot 100B are more generally described by equations (1)-(3), below:

$$Back EMF , {E}_{b} = {k}_{b} Φ N ; \qquad ( 1 )$$

$${V}_{BAT} = {E}_{b} + {R}_{tot} {I}_{BAT} + {L}_{m} di / dt ; and \qquad ( 2 )$$

$${I}_{m} = \frac{{V}_{BAT} - {E}_{b}}{{R}_{tot}} \qquad ( 3 )$$

The present technology provides an integrated circuit (IC) and associated processes that are able to isolate and amplify the AC ripple content of the commutation current of a BDCM by removing the DC/low frequency content from the waveform. The present technology may achieve this using a combination of analog circuitry and digital signal processing (DSP) in a single chip. By removing the DC and/or low frequency content from the commutation current of the BDCM, the IC disclosed herein is able to then maximize the signal-to-noise ratio (SNR) for the AC ripple portion of the input commutation current waveform. Doing so enables several additional advantageous operations for signal processing and diagnostics for the disclosed IC. It further enables a technically beneficial adaptivity of the IC according to the present technology which also allows for flexibility to handle variations in the specific system with which the disclosed IC is used (e.g., BDCMs of different models or from different manufacturers).

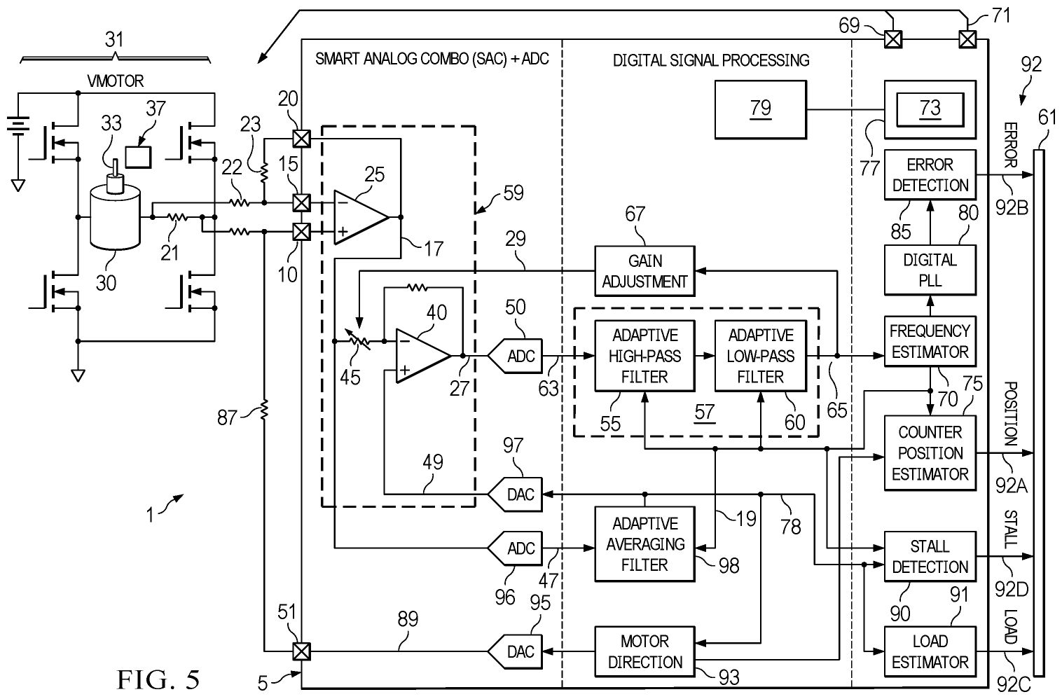

FIG. 5 shows a system 1 including an IC 5 (e.g., “chip” or “electronic circuit”) according to an implementation. As described in further detail, below, IC 5 performs counting of the AC ripples of the commutation current from BDCM 30, as shown, for example, in FIG. 4A. This enables determination of a number of rotations of the shaft 33 of BDCM 30 and thus also extent of linear motion of a mechanism like a lock bolt operably to the shaft 33 by way of a gear or gear train of movable structure 37. Equations (4) and (5) may be used for this purpose.

For a BDCM 30 having an even number of poles, the number of shaft 33 rotations (Rotations_{even #poles}) in a relevant period of time is computed using equation (4), as follows:

$${Rotations}_{even poles} = \frac{Determined Count}{ of BDCM poles} \qquad ( 4 )$$

For a BDCM 30 having an odd number of poles, the number of shaft 33 rotations (Rotations_{odd #poles}) in a relevant period of time is computed using equation (5), as follows:

$${Rotations}_{odd poles} = \frac{Determined Count}{( of BDCM poles ) * 2} \qquad ( 5 )$$

System 1 includes a motor driver circuit 31 operably coupled to BDCM 30. Motor driver circuit 31 may receive control signals to vary speed and rotational direction of shaft 33, according to devices and methods known to persons having ordinary skill in the art. In some embodiments, IC 5 may include analog and/or digital circuitry and/or other means for generating and transmitting motor control signals 71 to motor driver circuitry 31 via pins 69.

IC 5 may include pins 10, 15 and 20 to receive input signals from, among other possible sources, the commutation current from brushes 14 of BDCM 30. IC 5 may include at least two operational amplifiers 25 and 40. Pins 10 and 15 may be coupled to inputs of op-amp 25. Op-amp 25 converts the commutation current flowing through a resistor 21 from the BDCM 30 to a voltage inside the IC 5. A DC bias level of op-amp 25 is set on its non-inverting terminal (+) via pin 10 by an output of a pin 51, as further described below. As used herein, the terms “pin” or “pins” refer to means, such as electrical, optical, and/or electro-optical ports, plugs, or connectors through which electrical, optical, and/or electro-optical signals such as continuous, semi-continuous and/or pulsed voltage, current, or light may pass into and/or out of an electronic device or system such as the electronic circuit (e.g., IC 5), where such signals may, but do not necessarily have to, encode data for use in operation of the electronic circuit. An output of op-amp 25 is a voltage signal 17. Motor current may flow through another resistor 23 through pin 20 into IC 5 and then join the output of op-amp 25. A gain of op-amp 25 is set by a ratio of the resistance values of resistors 23 and 22 (R23/R22). Resistor 21 may convert the motor current from BDCM 30 to a voltage. Because op-amp 25 takes its inputs from both sides of resistor 21, op-amp 25 may convert a differential voltage to a single-ended voltage and gaining the signal with op-amp 25. Op-amp 25 with external resistors (including resistor 21) thereby may function as a current-to-voltage converter and inverting op-amp gain stage.

Inverting op-amp 40 is operably coupled to op-amp 25 to receive voltage signal 17 at its inverting terminal (−) by way of a variable resistor 45. Variable resistor 45 may be embodied in types, forms or configurations known to persons having ordinary skill in the art. For example, and without limitation, variable resistor 45 can be a rheostat, or a voltage-dependent resistor (VDR, a.k.a. varistor). IC 5 may also include at least two analog-to-digital converters (ADCs) 50 and 96. ADC 96 is operably coupled to the output of op-amp 25 to thereby receive signal 17. A further amplified voltage output signal 27 waveform of op-amp 40 passes to ADC 50 in IC 5. IC 5 may include digital-to-analog converter (DAC) 97 and an ADC 50. The DC level of signal 27 may be set by DAC 97. As such, an output signal 63 of ADC 50 is sampling the gained AC signal of interest, as further described below.

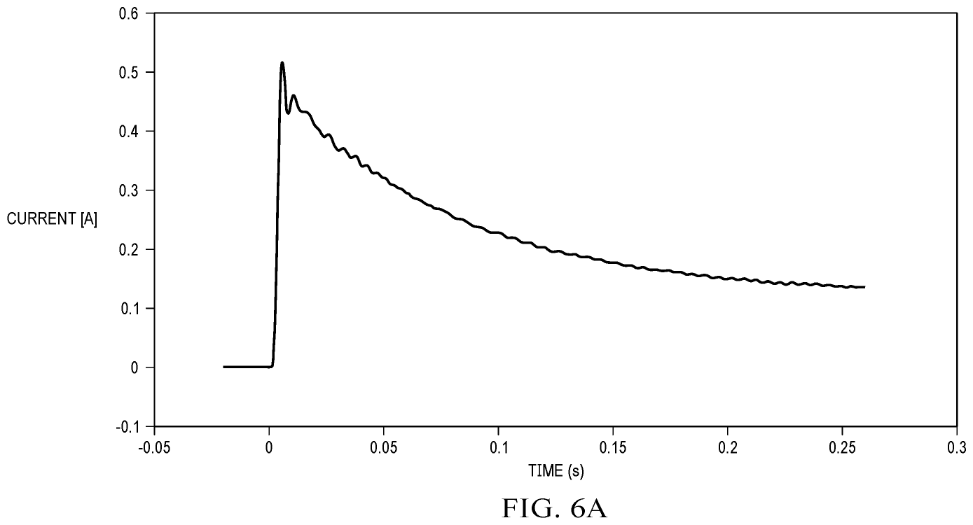

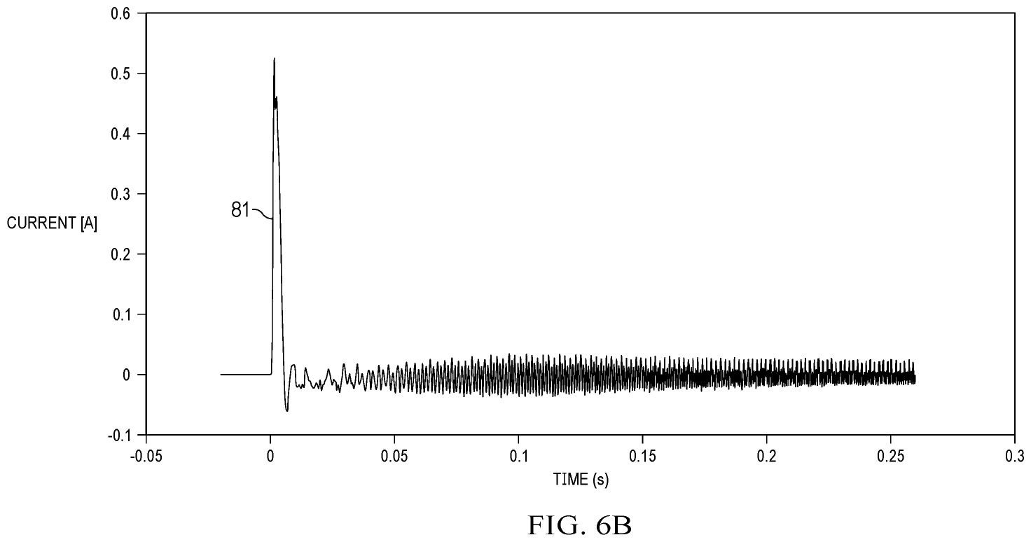

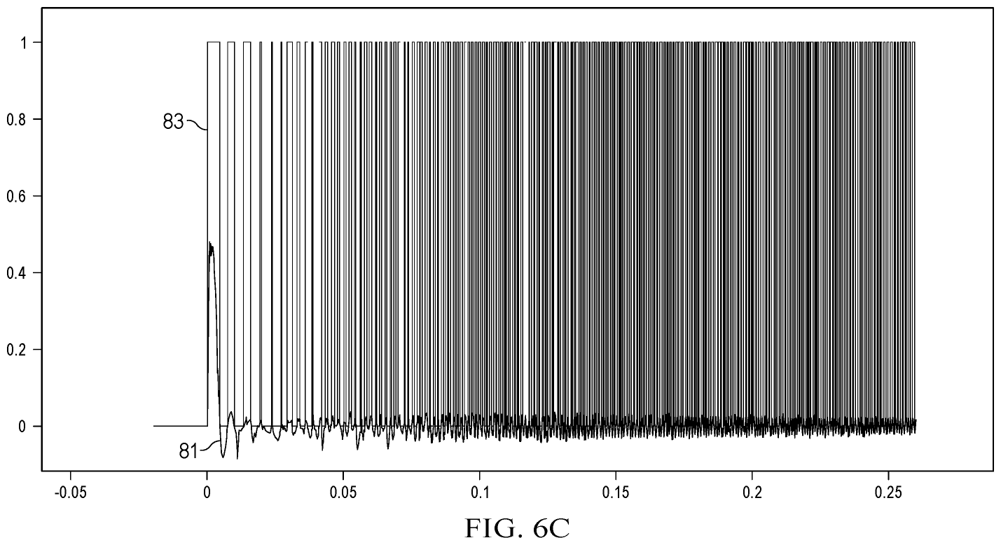

FIG. 6A is a plot of a signal output from DAC 97. The analog circuitry of IC 5 including op-amps 25 and 40 provide a high pass filter 59 in IC 5 that removes low frequency components of the commutation current of BDCM 30, as illustrated in the signal output from DAC 97 shown in FIG. 6A (e.g., as compared to the signal shown in FIG. 4A). Notably, this high pass filtering according to the present technology is accomplished without use of any capacitors (C) or inductors (L), in addition to resistors (R). Typically, to remove a low frequency components from a signal, a high pass filter requires a circuit including RC and/or LC physical components. Capacitors for this purpose tend to be large. They also tend to generate their own noise by their own piezo effect, which may add noise to the system (e.g., with vibration, capacitors themselves generate a signal that introduces noise). The absence of capacitor or inductor elements in IC 5 according to the present technology provide advantageous technical benefits to users such as reduced size and weight and less complex and costly manufacture resulting in lower costs. The high pass filter 59 provided by op-amps 25 and 40 are thereby simplified leading to more reliable operation for IC 5.

The output signal 63 of ADC 50 may pass into the DSP components of IC 5, starting with an adaptive high pass filter 55 to filter low frequency content of signal 63. An output of high pass filter 55 passes to an adaptive low pass filter 60 to filter high frequency content of signal 63. Together, high pass filter 55 and low pass filter 60 of IC 5 make a bandpass filter 57. Notably, although the high pass filter 55 and low pass filter 60 are shown as two separate DSP components in FIG. 5, in some embodiments, IC 5 may instead have a single digital bandpass filter 57 to perform the functions of high pass filter 55 and low pass filter 60 as described herein according to the present technology.

In one example, a frequency of the commutation current of a particular BDCM 30 is 1.2 kHz, which is the frequency of interest for the AC ripple component of the amplified voltage signal 63. Signal 63 waveform may contain frequency components above and below (e.g., the DC component) the frequency of interest. In the example, a signal 65 output from adaptive bandpass filter 57 may thus be a waveform having essentially only the frequency of interest for the amplified AC ripple, e.g., 1.2 kHz. In some examples, the aforementioned frequency of interest may be a range of frequencies (e.g., 1.15 kHz to 1.25 kHz), and the adaptive bandpass filter 57 may be configured to output signal 65 as a waveform having that range of frequencies.

IC 5 may also include, or be operably coupled to, one or more non-transitory computer readable media (NT-CRM) 73, either included with, or as a separate component from, a memory storage device 77. In some embodiments, the NT-CRM 73 and/or memory storage device 77 may store data including parameters of BDCM 30 such as its number of poles and the aforementioned frequency of interest. One advantage of system 1 and IC 5 according to the present technology is that software and/or firmware stored on NT-CRM 73 and/or in memory storage device 77 may be used without modification for a variety of different makes and models of BDCM 30 as may be used with system 1. For instance, cutoffs of the high pass filter 55 and low pass filter 60 may be set in a window or range of frequency about the known or expected frequency of interest for a particular BDCM 30 (e.g., 1.2 kHz+/−0.2 kHz). This frequency range may accommodate variations in make or model of BDCM 30 being used interchangeably in system 1 (e.g., as a part of a periodic maintenance schedule) without having to modify the software, firmware, or stored parameters. More substantial changes in system 1 such as using a BDCM 30 having a different operating voltage or number of poles would, however, necessitate such a change. Further, and as described below in greater detail, the adaptive filtering techniques used in the DSP aspects of IC 5 provide additional technically beneficial advantages that can accommodate variations in system 1 parameters as may be seen in operation of IC 5 for same or different BDCMs 30 being used therewith.

In operation of IC 5, signal 65 is passed from adaptive bandpass pass filter 57 to a gain adjustment module 67. Signal 65 provides the waveform with the aforementioned frequency of interest for the AC ripple waveform of BDCM 30. Gain adjustment module 67 determines the amplitude of signal 65 (e.g., amplitude magnitude) and provides a responsive signal 29 to variable resistor 45 for adjusting a voltage of the inverting terminal (−) of op-amp 40. Signal 29 may be an analog signal encoding data (e.g., a voltage value or level) representative of the aforementioned amplitude of signal 65. In another embodiment, variable resistor 45 may be capable of being controlled digitally, and signal 29 may be a digital signal encoding data representative of the amplitude of signal 65. Where the amplitude of signal 65 as determined by gain adjustment module 67 is lower than expected according to a pre-determined value (or range of values) as stored, e.g., in NT-CRM 73 and/or memory storage device 77, signal 29 directs variable resistor 45 to decrease its resistance to thereby increase the voltage on the inverting terminal (−) of op-amp 40 so as to increase the amplitude of the output signal 27. Conversely, where the amplitude of signal 65 as determined by gain adjustment module 67 is higher than expected according to the pre-determined value (or range of values), signal 29 directs variable resistor 45 to increase its resistance to thereby decrease the voltage on the inverting terminal (−) of op-amp 40 so as to decrease the amplitude of the output signal 27. Gain adjustment module 67 ensures a maximum dynamic range is maintained for the bandpass filter 57 (e.g., the combination of adaptive high pass filter 55 and adaptive low pass filter 60) and the associated downstream operations, as described below.

FIG. 6B is a plot of signal 65 output as a waveform 81 provided by the adaptive bandpass filter 57. As shown in FIG. 6B, signal 65 has the aforementioned frequency of interest of the AC ripple of the commutation current of BDCM 30. In some embodiments, the above described analog and digital signal processing provides signal 65 as a subtraction of the base commutation current of BDCM 30 (e.g., as shown in FIG. 4A) from signal 63. The waveform of FIG. 6B also has at least an approximately consistent amplitude, as compared to FIG. 4A, for example. The adaptive filters 55 and 60 forming the bandpass filter 57 in the DSP portion of IC 5 thus prepare signal 65 from signal 63 for further processing according to the present technology, as described below.

In operation of IC 5, signal 65 is also passed from adaptive bandpass filter 57 to a frequency estimator module 70. Frequency estimator module 70 estimates the frequency of signal 65, and thus also the AC ripple of the commutation current of BDCM 30, using a comparator, or equivalent technique. Frequency estimator module 70 counts the peaks of signal 65 per unit time and compares that data to what is known on the system 1 (e.g., the aforementioned frequency of interest for BDCM 30).

FIG. 6C is a plot of example output signal 19 of frequency estimator 70. The waveform 83 overlaid on the waveform 81 in FIG. 6C is a fully positive waveform having constant amplitude to generate a clock for a counter position estimator module 75 of IC 5 facilitate counting thereby of the recreated AC ripples of the commutation current of the BDCM 30. Counter position estimator module 75 uses the number of poles of BDCM 30 (e.g., stored in NT-CRM 73 and/or memory storage device 77) along with the determined count over a period of time such data is received to determine the number of rotations of the BDCM 30 shaft 33 in that time period.

Using the gear train information stored in NT-CRM 73 and/or memory storage device 77, counter position estimator module 75 may then apply the determined number of rotations to compute a linear distance traveled by a mechanism (e.g., bolt of a smart lock) in the relevant time period. The direction of rotation of shaft 33 may be determined by motor direction module 93, according to the polarity of the AC ripple waveform during start up. This result may be transmitted as an output signal 92A of IC 5 to other subsystem(s) to various useful ends. In some embodiments, motor direction module 93 may be coupled to counter position estimator module 75, and output signal 92A may include data representative of both the direction of rotation of shaft 33 and the computed linear distance traveled by the mechanism. Notably, the number of rotations of shaft 33 may be determined fractionally, which then enables counter position estimator module 70 to compute a precise position value for the mechanism operably coupled to shaft 33. High precision applications like linear actuators or robotics may thus make use of BDCMs 30 having appropriate numbers of poles (e.g., greater than 4 poles) such that the present technology may effectively apply IC 5 and the processes described herein.

IC 5 may further include a digital phase locked loop (DLL) module 80 operatively coupled to and between frequency estimator module 70 and an error detection module 85. DLL 80 and error detection 85 modules together enable a comparison between the frequency determined by frequency estimator module 70 and an internally maintained clock of, or used by, IC 5. Error detection module 85 may thus determine whether or not shaft 33 is spinning fast enough based on a value (or range of values) stored in NT-CRM 73 and/or memory storage device 77. Error detection module 85 may provide a responsive output 92B signal encoding data representative of an error condition for BDCM 30 or the wider system 1. One or more data points or data sets may be stored in NT-CRM 73 and/or memory storage device 77 that, when observed by error detection module 85, may indicate specific failure mode(s) for BDCM 30 or system 1. Such an output signal 92B may take the form of a change in an LED light from green to red, or an audible sound, among other possibilities conceivable to persons of ordinary skill in the art. A plurality of different deviant operational conditions may collectively or individually be indicated to a user of IC 5 but as different types of output signals 92 in some embodiments.

Signal 19 may also be passed to the adaptive high pass filter 55 and low pass filter 60 in operation of IC 5 to maintain or adjust their frequency cutoff values (or ranges of values) to ensure those values (or ranges of values) are appropriate for the actual frequency of interest determined by frequency estimator module 70. This aspect of the DSP provided by IC 5 further illustrates the adaptive nature of operations as described herein according to the present technology.

Signal 19 may also be passed to an adaptive averaging filter 98 in operation of IC 5. Adaptive averaging filter 98 may receive an output of an ADC 96, which receives signal 17. Adaptive averaging filter 98 may function as a digital low pass filter in IC 5 to determine the average DC/low frequency waveform. In operation of IC 5, adaptive averaging filter 98 may determine and pass a signal 78 encoding data representative of a DC value of the filtered waveform to DAC 97, which may be coupled to the non-inverting terminal (+) of op-amp 40 to maintain or adjust the DC bias thereof. This aspect of the DSP provided by IC 5 further illustrates the adaptive nature of operations including signal feedback as described herein according to the present technology.

Adaptive averaging filter 98 may also pass signal 78 to a load estimator module 91 in operation of IC 5. Increased load on shaft 33 of BDCM 30 will increase the average DC value of signal 78 and vice versa. Load estimator module 91 uses the value of signal 78 to determine an estimate of the load on shaft 33 and compares the load estimate to a known or expected load value for BDCM 30 stored in NT-CRM 73 and memory storage device 77. A stall condition or other increase in load for BDCM 30 would be expected to cause a rise in the DC value of signal 78 with a lack of AC ripple determined by frequency estimator module 70. Conversely, a decrease in load (e.g., where a gear is disengaged from shaft 33 or from another gear in the gear train) would cause a decrease in the DC value of signal 78 below an expected value or range of values. Where the shaft 33 load determined by load estimator module 91 deviates by a predetermined amount from the expected value, load estimator module 91 may provide a load output signal 92C and/or stall output signal 92D encoding data representative of a deviation from the expected operating condition of BDCM 30 or the wider system 1. Such output signal(s) (load output signal 92C and/or stall output signal 92D) may take the form of a change in an LED light from green to red, or an audible sound, among other possibilities conceivable to persons of ordinary skill in the art. The nature of such output signal(s) (load output signal 92C and/or stall output signal 92D) by IC 5 according to the present technology may be used, at least in part, by one or more subsystems separate and apart from IC 5.

Signals 19 and 78 may be further passed to a stall detection module 90 in operation of IC 5. Stall condition module 90 may detect a lowered or zero frequency from frequency estimator module 70 along with, or instead of, a high DC value from adaptive averaging filter 98, each of which deviates from an expected value (or expected ranges of values) to determine that BDCM 30 is in an abnormal stall condition. In such cases for system 1, stall condition module 90 may provide a responsive output 92D signal encoding data representative of a stall condition as a deviation from the expected operating condition of BDCM 30 or the wider system 1. Such an output signal 92D may take the form of a change in an LED light from green to red, or an audible sound, among other possibilities conceivable to persons of ordinary skill in the art.

Adaptive averaging filter 98 may further pass signal 78 to a motor direction module 93 in operation of IC 5. Motor direction module 93 may determine the polarity of current to responsively provide a signal encoding data representative of the direction of rotation of shaft 33 of BDCM 30. In some embodiments, this signal is passed to the counter position estimator module 75 to facilitate the determination of linear position of mechanism 28 (e.g., smart lock bolt). Motor direction module 93 is operatively coupled to a DAC 95 of IC 5. DAC 95 outputs a signal 89 via pin 51 and to pin 10 of IC 5. Signal 89 passes through a resistor 87, which is operably coupled to the non-inverting terminal (+) of op-amp 25 to thereby set its DC bias level.

Actively modifying the DC bias levels of op-amps 25 and 40 by the outputs of DACs 95 and 97, respectively, ensures that signal 63 used for the DSP components of IC 5 is maintained at or near mid-reference (aka “mid-rail”), where ADC 50 uses supply and ground as its reference. Signal 63 is thus passed without DC/low frequency content to enable SNR to be advantageously maximized for the DSP operations of IC 5.

The presence, use, and nature of outputs 92 by IC 5 according to the present technology may be used, at least in part, by one or more subsystems separate and apart from IC 5.

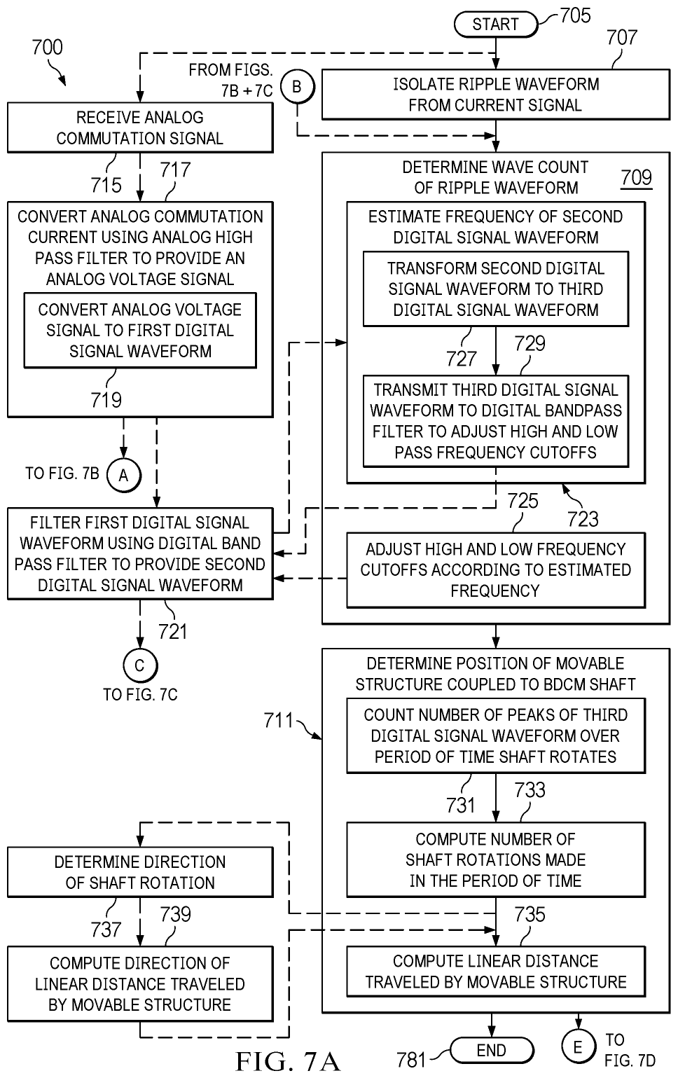

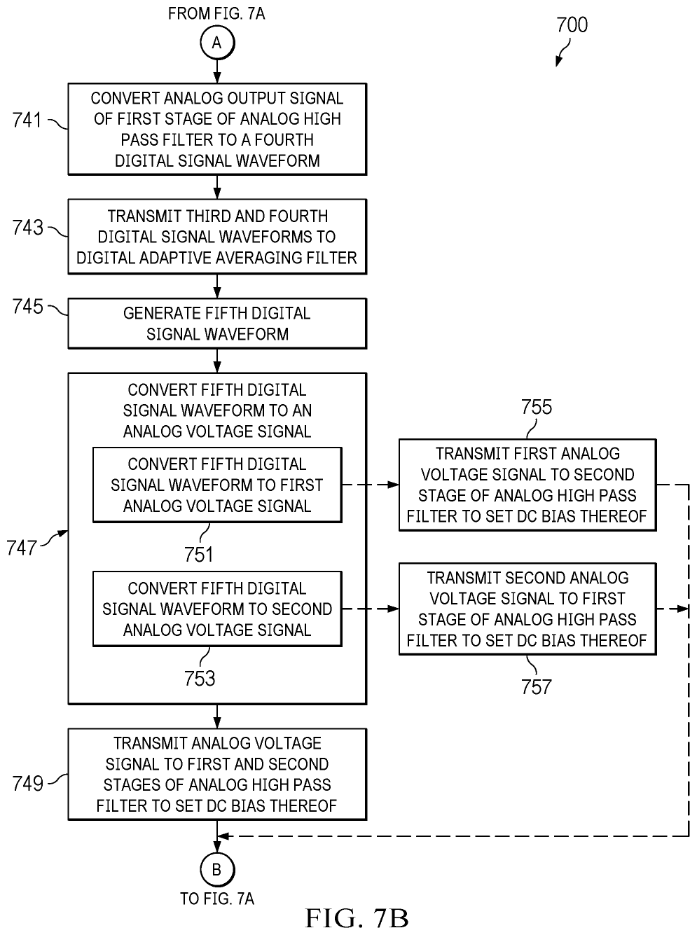

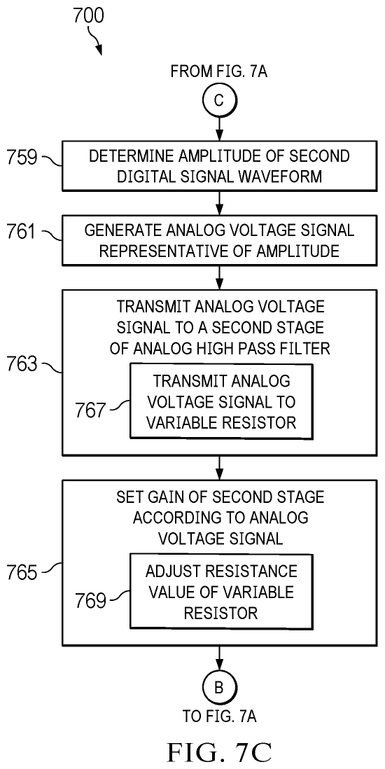

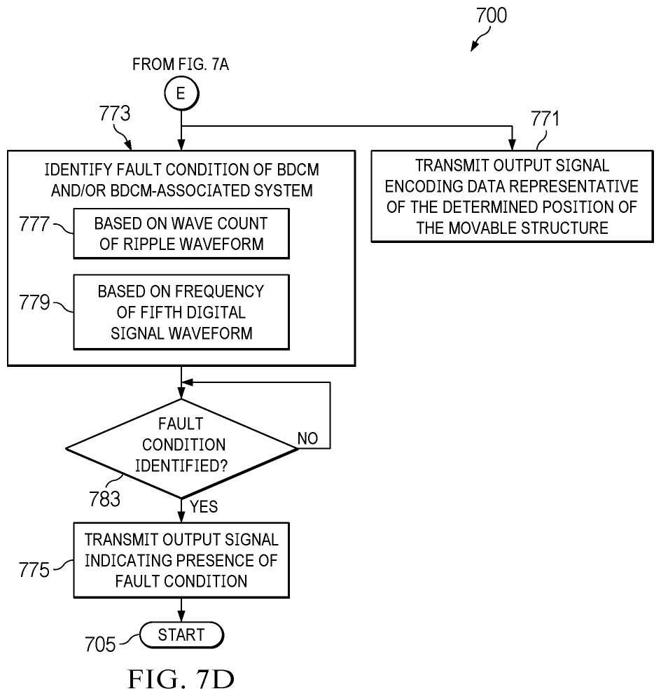

FIGS. 7A-7D depict an operational sequence of a method 700 for operating an electronic device (e.g., IC 5 shown in FIG. 5) according to an implementation of the present technology. NT-CRM 73 may have stored thereon program instructions (e.g., software and/or firmware) which, when executed by at least one processor (e.g., processor 79), cause machine, device, or system (e.g., an electronic device, such as IC 5) to perform, execute, or otherwise perform, at least in part, one or more of the processes or steps of method 700, as described herein. In some embodiments, method 700 according to the present technology is embodied in a method of operating an integrated circuit (e.g., IC 5).

As used herein, “processor” or “at least one processor” means analog and/or digital circuitry configured to direct various components of the disclosed electronic circuit (e.g., IC 5) to function according to a predefined logical scheme of operation. Processor(s) 79 may, at least in part, utilize program instructions encoded as software and/or firmware and stored in one or more memory storage devices 77 for use by processor(s) 79 to read, write and delete useful data, and to perform processor 79 mediated arithmetical operations of various types so as to achieve the various useful and practically advantageous ends of the present technology for the benefit of users thereof. Examples of processor(s) 79 include microcontrollers, DSPs, general purpose central processing units (CPUs), application specific processors or circuits (e.g., application specific integrated circuits(ASICs)), and logic devices (e.g., field programmable gate arrays (FPGAs)), as well as any other type of processing device, combinations, or variations thereof. Processor(s) 79 can be implemented within a single processing device but can also be distributed across multiple processing devices or sub-systems that cooperate in executing program instructions.

With reference to various features of the hitherto described figures, method 700 may commence from a start state 705. Start state 705 may include a voltage first being applied to BDCM 30 and a commutation current beginning to flow toward IC 5 from the brushes 14 of BDCM 30. Method 700 may include the step of isolating 707 the above described AC ripple waveform from the current signal (e.g., passing into IC 5 via pin 15) originating from BDCM 30. Method 700 may also include the step of determining 709 a frequency of the AC ripple waveform. Method 700 may further include the step of determining 711 the position of movable structure 37 operably coupled to shaft 33 of BDCM 30 according to the frequency of the AC ripple waveform. Method 700 may conclude at an end state 781. End state 781 may include a lack of voltage being applied to BDCM 30 and the commutation current no longer flowing toward IC 5 from the BDCM 30 brushes 14.

In some examples, method 700 may also include the step of receiving 715 the current signal originating from BDCM 30 via pin 15 as an analog commutation current signal originating at brushes 14 of BDCM 30. In an example, method 700 may further include the step of converting 717 the aforementioned analog commutation current signal to an analog voltage signal waveform (e.g., signal 27) using an analog high pass filter (e.g., high pass filter 59 having the combined stages of op-amps 25 and 40, hereinafter referred to as first and second stages, respectively).

In some examples, the converting 717 step of method 700 may include converting 719 (e.g., using ADC 50) the analog voltage signal waveform 27 to a first digital signal waveform (e.g., signal 63). In the example, method 700 may also include the step of filtering 721 the first digital signal waveform 63 using digital bandpass filter 57 (e.g., by processor(s) 79 and/or by DSP techniques using adaptive high pass filter 55 and low pass filter 60 under command of processor(s) 79 executing program instructions stored in, e.g., NT-CRM 73). The filtering 721 may thereby provide a second digital signal waveform (e.g., signal 65). The digital bandpass filter 57 utilized for the filtering 721 may have high and low frequency cutoffs set according to an expected frequency of the isolated 707 AC ripple waveform ultimately derived according to the present technology from the commutation current signal entering IC 5 via pin 15.

In some examples, the determining 709 step of method 700 may include estimating 723 (e.g., by processor(s) 79 and/or by DSP techniques using frequency estimator module 70 under command of processor(s) 79 executing program instructions stored in, e.g., NT-CRM 73) the frequency of the second digital signal waveform 65. In an example, method 700 may also include adjusting 725 high and low frequency cutoffs of the digital bandpass filter 57 according to at least the estimated 723 frequency of the second digital signal waveform 65. The adjusting 725 step of method 700 represents one of the several technically beneficial adaptive feedback features in operation of IC 5 according to the present technology.

In some examples, the estimating 723 step of method 700 may include transforming 727 the second digital signal waveform 65 to a third digital signal waveform (e.g., signal 19) having a fully positive polarity to facilitate counting of both rising and falling peaks of the ripple waveform as represented by the second digital signal waveform 65. For the transforming 727 step, method 700 may make use of, for example and without limitation, DSP techniques using a comparator under command of processor(s) 79 executing program instructions stored in, e.g., NT-CRM 73. In some examples, method 700 may further include transmitting 729 the third digital signal waveform 19 to digital bandpass filter 57 to adjust the high and low frequency cutoffs of the digital bandpass filter 57 according to at least the estimated 723 frequency of the second digital signal waveform 65. For the transmitting 729 step, method 700 may make use of, for example and without limitation, digital and/or analog electronic means for sending signals from place to place within IC 5, where such means may be under command of processor(s) 79 executing program instructions stored in, e.g., NT-CRM 73. The transmitting 729 step of method 700 represents another one of the several technically beneficial adaptive feedback features in operation of IC 5 according to the present technology.

In some examples of method 700, the step of determining 711 the position of the movable structure 37 may include counting 731 (e.g., by processor(s) 79 and/or by DSP techniques using counter position estimator module 75 under command of processor(s) 79 executing program instructions stored in, e.g., NT-CRM 73) the number of peaks of the third digital signal waveform 19 over a period of time the shaft 33 rotates (e.g., continually, or near continually, rotating). In some examples, method 700 may further include the step of computing 733 (e.g., by processor(s) 79 and/or by DSP techniques using counter position estimator module 75 under command of processor(s) 79 executing program instructions stored in, e.g., NT-CRM 73) a number of rotations of shaft 33 made in the period of time according to: the counted number of peaks, and the number of BDCM 30 poles.

In some examples, the determining 711 step of method 700 may also include computing 735 (e.g., by processor(s) 79 and/or by DSP techniques using counter position estimator module 75 under command of processor(s) 79 executing program instructions stored in, e.g., NT-CRM 73) a linear distance traveled by the movable structure 37 further according to known gear train information for one or more gears 26 operably coupled to and between shaft 33 and movable structure 37. Equations (4) and (5) may be used, at least in part, for this purpose. In some examples, method 700 may further include the step of determining 737 (e.g., by processor(s) 79 and/or by DSP techniques using counter position estimator module 75 under command of processor(s) 79 executing program instructions stored in, e.g., NT-CRM 73) a direction of rotation of shaft 33 (e.g., CW direction 18 or CCW direction 3) according to a polarity of the incoming analog commutation current at pin 15 or a digital equivalent thereof (e.g., signal 47). The determined 737 shaft 33 rotation direction may be used in the determining 711 step of method 700 for computing 739 (e.g., by processor(s) 79 and/or by DSP techniques using counter position estimator module 75 under command of processor(s) 79 executing program instructions stored in, e.g., NT-CRM 73) a direction (e.g., left 32-1 or right 32-2) of the linear distance traveled by movable structure 37. The computing 739 step of method 700 represents yet another one of the several technically beneficial adaptive feedback features in operation of IC 5 according to the present technology.

In some examples, method 700 may also include the step of converting 741 (e.g., using ADC 96) an analog output signal (e.g., signal 17) of the first stage 25 of the analog high pass filter 59 to a fourth digital signal waveform (e.g., signal 47). In some examples, method 700 may further include the step of transmitting 743 (e.g., using the aforementioned means for sending signals from place to place within IC 5) the third digital signal waveform 19 and fourth digital signal waveform 47 to the digital adaptive averaging filter 98.

In some examples, method 700 may further include the step of generating 745 (e.g., by processor(s) 79 and/or by DSP techniques using digital adaptive averaging filter 98 under command of processor(s) 79 executing program instructions stored in, e.g., NT-CRM 73) a fifth digital signal waveform (e.g., signal 78) representative of an average amplitude of the third digital signal waveform 19 and fourth digital signal waveform 47. In some examples, method 700 may also include the step of converting 747 (e.g., by DAC 97) the fifth digital signal waveform 78 to an analog voltage signal. Method 700 may also include the step of transmitting 749 (e.g., using the aforementioned means for sending signals from place to place within IC 5) the analog voltage signal to the first stage 25 and second stage 40 of the analog high pass filter 59 to set a DC bias for the first stage 25 and second stage 40.

In some examples of method 700, converting 747 the fifth digital signal waveform 78 may include the steps of: converting 751 (e.g., by DAC 97) the fifth digital signal waveform 78 to a first analog voltage signal (e.g., signal 49); and converting 753 (e.g., by DAC 95) the fifth digital signal waveform 78 to a second analog voltage signal (e.g., signal 89). In some examples, method 700 may further include the steps of transmitting 755 the first analog voltage signal 49 to second stage 40 to set a DC bias for second stage 40; and transmitting 757 the second analog voltage signal 89 to first stage 25 to set a DC bias for first stage 25. The transmitting steps 755 and 757 may be accomplished in method 700 using the aforementioned means for sending signals from place to place within IC 5.

The transmitting (755 and 757) step(s) as described by way of examples above for method 700 represent(s) still another one of the several technically beneficial adaptive feedback features in operation of IC 5 according to the present technology.

In some examples, method 700 may also include the step of determining 759 (e.g., by processor(s) 79 and/or by DSP techniques using gain adjustment module 67 under command of processor(s) 79 executing program instructions stored in, e.g., NT-CRM 73) an amplitude of the second digital signal waveform 65. In some examples, method 700 may further include the step of generating 761 (e.g., by processor(s) 79 and/or by DSP techniques using gain adjustment module 67 under command of processor(s) 79 executing program instructions stored in, e.g., NT-CRM 73) a signal (e.g., signal 29) representative of the determined 759 amplitude.

In some examples, method 700 may additionally include the step of transmitting 763 (e.g., using gain adjustment module 67 and/or the aforementioned means for sending signals from place to place within IC 5) signal 29 to second stage 40 of analog high pass filter 59. In some examples, method 700 may also include setting 765 a gain of second stage 40 according to signal 29. The transmitting 763 and setting 765 steps of method 700 represent yet another one of the several technically beneficial adaptive feedback features in operation of IC 5 according to the present technology.

In some examples of method 700, the step of transmitting 763 signal 29 to second stage 40 may include transmitting 767 signal 29 to variable resistor 45 operably coupled to the second stage 40. In some examples, the method 700 step of setting 765 the gain of second stage 40 may include adjusting 769 a resistance value of variable resistor 45 according to signal 29. The method 700 step of adjusting 769 the resistance value of variable resistor 45 may include adjusting the resistance value in proportion to the determined 759 amplitude of second digital signal waveform 65. The transmitting 767 and adjusting 769 steps of method 700 represent yet another one of the several technically beneficial adaptive feedback features in operation of IC 5 according to the present technology.

In some examples of method 700, the step of converting 717 the incoming analog commutation current at pin 15 may include converting the analog commutation current to the analog voltage signal waveform 27 in the absence of using any discrete capacitor components in either of the two stages (stage 25, stage 40) of analog high pass filter 59. In some examples of method 700, the step of converting 717 the incoming analog commutation current at pin 15 may include converting the analog commutation current to the analog voltage signal waveform 27 in the absence of using any discrete inductor components in either of the two stages (stage 25, stage 40) of analog high pass filter 59. In some examples of method 700, the step of converting 717 the incoming analog commutation current at pin 15 may include converting the analog commutation current to the analog voltage signal waveform 27 in the absence of using any discrete capacitor components, and in the absence of using any discrete inductor components, in either of the two stages (25, 40) of analog high pass filter 59.

In some examples, method 700 may further include the step of transmitting 771 an output signal 92A encoding data representative of the determined 711 position of the movable structure 37 to a subsystem 61 for use thereby. In some examples, method 700 may also include the step of identifying 773 (e.g., by processor(s) 79 and/or by DSP techniques using error detection 85, counter position estimator 75, stall detection 90, and/or load estimator 91 modules under command of processor(s) 79 executing program instructions stored in, e.g., NT-CRM 73) a fault condition of BDCM 30 and/or a BDCM 30-associated system (e.g., 1 or 61). In some examples, method 700 may additionally include a logical branch 783 in which, for example and without limitation, processor(s) 79 and/or by DSP techniques using error detection 85, counter position estimator 75, stall detection 90, and/or load estimator 91 modules determine whether or not a fault (e.g., deviant operational) condition has been identified 773. In an example, where logical branch 783 determines that the fault condition has not been identified 773, method 700 may loop back from logical branch 783 to the identifying 773 step. By contrast, method 700 may proceed to a transmitting 775 step where logical branch 783 determines that the fault condition has been identified 773. In the latter case, and in response to identifying 773 the fault condition, one or more output signals 92 indicating the presence of the fault condition may be transmitted 775 out of IC 5. For instance, the one or more output signal(s) 92 may be transmitted 775 to a user of BDCM 30 and/or a BDCM 30-associated system (e.g., 1 or 61). The transmitting 775 step may be accomplished in method 700 using the aforementioned means for sending signals from place to place within, or to outside, IC 5.

In some examples of method 700, the step of identifying 773 the fault condition may further include identifying 777 the fault condition based at least in part on a departure of the frequency, and/or wave count, of the AC ripple waveform of BDCM 30 from an expected frequency value or range of values. Additionally, or instead, in an example, identifying 773 the fault condition in method 700 may include identifying 779 the fault condition based at least in part on a property of, or data derived by or encoded from, the fifth digital signal waveform 78.

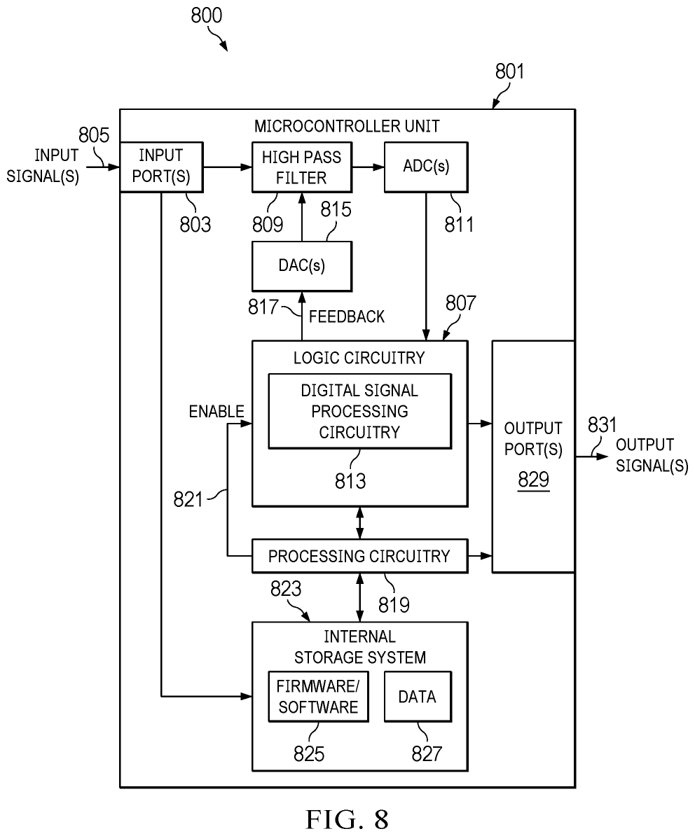

FIG. 8 illustrates computing system 800 that is representative of any system or collection of systems in which the various processes, programs, services, and scenarios disclosed herein may be implemented. Examples of computing system 800 include, but are not limited to, microprocessors, integrated circuits, system-on-a-chip (SOC), server computers, routers, web servers, cloud computing platforms, and data center equipment, as well as any other type of physical or virtual server machine, physical or virtual router, container, and any variation or combination thereof. In one embodiment, as shown in FIG. 8, the electronic circuit (e.g., IC 5) may be embodied in a microcontroller 801 configured to provide accurately determined rotational positions of a shaft 33 of a BDCM 30 and also position(s) of movable structure 37 coupled to the shaft 33 without requiring any external sensors or other components for this purpose other than the disclosed electronic circuit, as described above with reference to FIGS. 5 and 7A-7D.

As described above, microcontroller unit 801 may take on any of a wide variety of configurations. Here, a simplified example configuration is provided for an electronic circuit (e.g., IC 5) including processor(s) 79 as described above with reference to FIGS. 5 and 7A-7D and embodied in microcontroller unit 801. In the embodiment shown in FIG. 8, microcontroller unit 801 may include input port(s) 803 which may correspond to pins 10, 15 and 20 of IC 5. Input port(s) 803 may include circuitry configured to receive input signal(s) 805 from source(s) external to microcontroller unit 801, such as the commutation current signal from brushes 14 of BDCM 30.

Microcontroller unit 801 may include logic circuitry 807 operably coupled to input port(s) 803 to receive input signal(s) 805 therefrom. In some embodiments, input signal(s) 805 may be transmitted via input port(s) 803 to logic circuitry 807 by way of one or more intervening functional components of microcontroller unit 801. In the example illustrated in FIG. 8, such intervening components may include a high pass filter 809 and ADC(s) 811. High pass filter 809 may be coupled to and between input port(s) 803 and ADC(s) 811. In some embodiments, high pass filter 809 may correspond to high pass filter 59, and ADC(s) 811 may correspond to ADCs 50 and 96, of IC 5 as described above with reference to FIGS. 5 and 7A-7D. Signal(s) converted by ADC(s) 811 may include, and provide the functionality of, signals 17 and/or 27, as described above with reference to FIGS. 5 and 7A-7D

Logic circuitry 807 may include DSP components 813. DSP components 813 may correspond to one or more of the following components of IC 5 as described above with reference to FIGS. 5 and 7A-7D: bandpass filter 57, gain adjustment module 67, motor direction module 93 and adaptive averaging filter 98. Logic circuitry 807 including at least some of the DSP components 813 may be configured to implement or otherwise perform, at least in part, one or more of the functions of the aforementioned components (bandpass filter 57, gain adjustment module 67, motor direction module 93 and adaptive averaging filter 98) in operation of microcontroller unit 801 according to the present technology.

Microcontroller unit 801 may include DAC(s) 815 operable coupled to and between high pass filter 809 and logic circuitry 807. In some embodiments, DAC(s) 815 may correspond to DACs 95 and 97 of IC 5 as described above with reference to FIGS. 5 and 7A-7D. In operation along with DSP components 813, logic circuitry 807 may transmit feedback signal(s) 817 to high pass filter 809 by way of DAC(s) 815. Feedback signal(s) 817 converted by DAC(s) 815 may include, and provide the functionality of, one of more of signals 29 and 89, as described above with reference to FIGS. 5 and 7A-7D.

Microcontroller unit 801 may include processing circuitry 819 operably coupled to logic circuitry 807. In some embodiments, processing circuitry 819 may correspond to processor(s) 79 of IC 5 as described above with reference to FIGS. 5 and 7A-7D. Processing circuitry 819 may include analog and/or digital circuitry components capable of directing logic circuitry 807 and other components of microcontroller unit 801 to process or otherwise functionally manipulate data and/or signals encoding data to determine and provide accurately determined rotational positions of a shaft 33 of a BDCM 30 and also position(s) of movable structure 37 coupled to the shaft 33, as described above. Processing circuitry 819 may also transmit an enable signal(s) 821 to logic circuitry 807 activate all or part of the functionality of the components thereof. In an example embodiment, receipt of enable signal(s) 821 by logic circuitry 807 may correspond to entry into the start state 705 in method 700, as described above with reference to FIGS. 7A-7D.

Microcontroller unit 801 may also include output port(s) 829 operably coupled to logic circuitry 807 and/or processing circuitry 819. In some embodiments, output port(s) 829 enable one or more output signals 831 encoding data representative of results of operations completed by logic circuitry 807 and/or processing circuitry 819 to be passed to user(s) or subsystem(s) of or associated with microcontroller unit 801. In an example, the aforementioned output signal(s) 831 may include output signals 92, as described above with reference to FIGS. 5 and 7A-7D.

Microcontroller unit 801 may include an internal storage system 823 operably coupled to processing circuitry 819. In some embodiments, internal storage system 823 may correspond to memory storage device(s) 77 and/or NT-CRM 73 of IC 5. Processing circuitry 819 may include microprocessor(s) and other circuitry that retrieves and executes firmware and/or software 825 stored in internal storage system 823 (e.g., on or in NT-CRM 73). Examples of processing circuitry 819 include, for example and without limitation, general purpose central processing units, application specific processors, and logic devices, as well as any other type of processing device, combinations, or variations thereof. Processing circuitry 819 can be implemented within a single processing device but can also be distributed across multiple processing devices or sub-systems that cooperate in executing program instructions.

Internal storage system 823 can comprise any non-transitory computer readable storage media capable of storing firmware and/or software 825 that is executable by processing circuitry 819. Internal storage system 823 can also include various data structures 827 which comprise one or more registers, databases, tables, lists, or other data structures. Storage system 823 can include volatile and nonvolatile, removable and non-removable media implemented in any method or technology for storage of information, such as computer readable instructions, data structures, program modules, or other data. In this example embodiment, internal storage system 823 includes flash memory within microcontroller unit 801 which also stores configuration (e.g., parameters of BDCM 30, and high and low frequency cutoffs for bandpass filter 57).

Storage system 823 can be implemented as a single storage device but can also be implemented across multiple storage devices or sub-systems co-located or distributed relative to each other. Storage system 823 can comprise additional elements, such as a controller, capable of communicating with processing circuitry 819. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that can be accessed by an instruction execution system, as well as any combination or variation thereof.

Firmware and/or software 825 can be implemented in program instructions and among other functions can, when executed by microcontroller unit 801 in general or processing circuitry 819 in particular, direct microcontroller unit 801, or processing circuitry 819, to operate as described herein to determine and provide accurately determined rotational positions of a shaft 33 of a BDCM 30 and also position(s) of movable structure 37 coupled to the shaft 33 according to the present technology. Firmware and/or software 825 can include additional processes, programs, or components, such as operating system software, database software, or application software. Firmware and/or software 825 can also include firmware or some other form of machine-readable processing instructions executable by elements of processing circuitry 819. In at least one example implementation, the program instructions include various modules configured to direct processing circuitry 819 and/or logic circuitry 807 to determine and provide accurately determined rotational positions of a shaft 33 of a BDCM 30 and also position(s) of movable structure 37 coupled to the shaft 33.

In general, firmware and/or software 825 can, when loaded into processing circuitry 819 and executed, transform processing circuitry 819 overall from a general-purpose computing system into a special-purpose computing system customized to operate as described herein for a microcontroller unit 801 configured to determine and provide accurately determined rotational positions of a shaft 33 of a BDCM 30 and also position(s) of movable structure 37 coupled to the shaft 33, among other operations. Encoding firmware and/or software 825 on internal storage system 823 can transform the physical structure or state of internal storage system 823. The specific transformation of the physical structure or state can depend on various factors in different implementations of this description. Examples of such factors can include, but are not limited to the technology used to implement the storage media of internal storage system 823 and whether the computer-storage media are characterized as primary or secondary storage.

For example, if the computer-storage media are implemented as semiconductor-based memory, firmware and/or software 825 can transform the physical state of the semiconductor memory when the program is encoded therein. For example, firmware and/or software 825 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

### EXAMPLES

### Example 1

A first example according to the present technology provides a method. The method includes isolating a ripple waveform from a current signal originating from a BDCM. The method also includes determining a wave count of the ripple waveform. The method further includes determining a position of a movable structure operably coupled to a shaft of the BDCM according to the wave count of the ripple waveform. The method can also include the steps of: receiving the current signal as a commutation current signal originating at brushes of the BDCM; and converting the commutation current signal to an analog voltage signal waveform using a high pass filter. The converting step may include converting the analog voltage signal waveform to a first digital signal waveform, and the method may also include filtering the first digital signal waveform using a bandpass filter to provide a second digital signal waveform, where the bandpass filter has high and low frequency cutoffs set according to an expected frequency of the commutation current signal. Determining the wave count of the ripple waveform can include estimating a frequency of the second digital signal waveform.

The method can also include adjusting the high and low frequency cutoffs of the bandpass filter according to at least the estimated frequency of the second digital signal waveform. Estimating the frequency of the second digital signal waveform may include transforming, using a comparator, the second digital signal waveform to a third digital signal waveform having a fully positive polarity to facilitate counting of both rising and falling peaks of the ripple waveform as represented by the second digital signal waveform. The method may further include transmitting the third digital signal waveform to the bandpass filter to adjust the high and low frequency cutoffs of the bandpass filter according to at least the estimated frequency of the second digital signal waveform. Determining the position of the movable structure may include: counting the number of peaks of the third digital signal waveform over a period of time the shaft rotates; and computing a number of rotations of the shaft made in the period of time according to: the counted number of peaks, and a number of poles of the BDCM. Determining the position of the movable structure may further include computing a linear distance traveled by the movable structure further according to known gear train information for one or more gears operably coupled to and between the shaft and the movable structure.

The method may also include determining a direction of rotation of the shaft according to a polarity of the commutation current signal or a digital equivalent thereof. Determining the position of the movable structure may further include computing a direction of the linear distance traveled by the movable structure according to the direction of rotation of the shaft. The method may also include: converting an analog output signal of a first stage of the high pass filter to a fourth digital signal waveform; and transmitting the third and the fourth digital signal waveforms to an adaptive averaging filter. The method may also include generating, by the adaptive averaging filter, a fifth digital signal waveform representative of an average amplitude of the third and fourth digital signal waveforms. The method may further include converting the fifth digital signal waveform to an analog voltage signal.

The method may also include comprising transmitting the analog voltage signal to the first, and a second stage, of the high pass filter to set a DC bias for the first and second stages. Converting the fifth digital signal waveform may include: converting the fifth digital signal waveform to a first analog voltage signal; and converting the fifth digital signal waveform to a second analog voltage signal. The method may further include: transmitting the first analog voltage signal to the second stage to set a DC bias for the second stage; and transmitting the second analog voltage signal to the first stage to set a DC bias for the first stage. The method may also include: determining an amplitude of the second digital signal waveform; and generating a signal representative of the determined amplitude. The method may further include transmitting the analog voltage signal to a second stage of the high pass filter. The method may also include setting a gain of the second stage according to the analog voltage signal.

Transmitting the signal to the second stage may include transmitting the signal to a variable resistor operably coupled to the second stage. Setting the gain of the second stage may include adjusting a resistance value of the variable resistor according to the analog voltage signal. Adjusting the resistance value of the variable resistor may include adjusting the resistance value in proportion to the determined amplitude of the second digital signal waveform. Converting the commutation current signal may include converting the commutation current signal to the analog voltage signal waveform in the absence of any discrete capacitor components of the high pass filter. Converting the commutation current signal may include converting the commutation current signal to the analog voltage signal waveform in the absence of any discrete inductor components of the high pass filter.

The method may also include transmitting an output signal encoding data representative of the determined position of the movable structure to a subsystem for use thereby. The method may further include identifying a fault condition of at least one of: the BDCM, and a BDCM-associated system. The method may also include transmitting, in response to identifying the fault condition, an output signal indicating the presence of the fault condition to a user of the at least one of: the BDCM, and a BDCM-associated system. Identifying the fault condition may include identifying the fault condition based at least in part on a departure of the wave count of the ripple waveform from an expected wave count value or range of values. Identifying the fault condition may include identifying the fault condition based at least in part on a property of, or data derived by or encoded from, the fifth digital signal waveform.

### Example 2

A second example according to the present technology provides an electronic circuit. The electronic circuit includes at least one input port configured to receive input signals from outside of the electronic circuit, where the input signals include a current signal originating from a BDCM. The electronic circuit also includes logic circuitry coupled to the at least one input port. The logic circuitry is configured to: isolate a ripple waveform from the current signal; determine a wave count of the ripple waveform; and determine a position of a movable structure operably coupled to a shaft of the BDCM according to the wave count of the ripple waveform. The electronic circuit further includes at least one output port coupled to the logic circuitry and configured to transmit one or more output signals outside of the electronic circuit. The one or more output signals include data representative of the position of the movable structure determined by the logic circuitry. The at least one input port can be configured to receive the current signal as a commutation current originating at brushes of the BDCM, and the electronic circuit may also include a high pass filter coupled to the at least one input port and configured to convert the commutation current to a voltage signal waveform. The electronic circuit may further include a first ADC coupled to the high pass filter and configured to convert the voltage signal waveform to a first digital signal waveform, the electronic circuit may also include a bandpass filter coupled to the first ADC and configured to filter the first digital signal waveform to provide a second digital signal waveform, and the bandpass filter can have high and low frequency cutoffs set according to an expected frequency of the commutation current.

To determine the wave count of the ripple waveform, the logic circuitry may be further configured to estimate the frequency of the second digital signal waveform. The logic circuitry may be further configured to adjust the high and low frequency cutoffs of the bandpass filter according to at least the estimated frequency of the second digital signal waveform. The electronic circuit may also include a comparator coupled to the bandpass filter, where to estimate the frequency of the second digital signal waveform, the logic circuitry may be further configured to transform, using the comparator, the second digital signal waveform to a third digital signal waveform having a fully positive polarity to facilitate counting of both rising and falling peaks of the ripple waveform as represented by the second digital signal waveform.

The logic circuitry may be further configured to cause the third digital signal waveform to be transmitted to the bandpass filter to adjust the high and low frequency cutoffs of the bandpass filter according to at least the estimated frequency of the second digital signal waveform. To determine the position of the movable structure, the logic circuitry may be configured to: count the number of peaks of the third digital signal waveform over a period of time the shaft rotates; and compute a number of rotations of the shaft made in the period of time according to: the counted number of peaks, and a number of poles of the BDCM. To determine the position of the movable structure, the logic circuitry may be further configured to compute a linear distance traveled by the movable structure further according to known gear train information for one or more gears operably coupled to and between the shaft and the movable structure. The logic circuitry may be further configured to determine a direction of rotation of the shaft according to a polarity of the commutation current or a digital signal equivalent thereof.

To determine the position of the movable structure, the logic circuitry may be further configured to compute a direction of the linear distance traveled by the movable structure according to the direction of rotation of the shaft. The high pass filter may include a first stage and a second stage, and the electronic circuit may further include: an adaptive averaging filter, and a second ADC coupled to and between the first stage and the adaptive averaging filter, where the second ADC is configured to convert an analog output signal of the first stage to a fourth digital signal waveform, and where the logic circuitry is configured to cause the third and the fourth digital signal waveforms to be transmitted to the adaptive averaging filter. The logic circuitry may be further configured to generate, using the adaptive averaging filter, a fifth digital signal waveform representative of an average amplitude of the third and fourth digital signal waveforms. The electronic circuit may also include a DAC coupled to and between the adaptive averaging filter and the high pass filter, where the DAC is configured to convert the fifth digital signal waveform to an analog voltage signal.

The logic circuitry may be further configured to cause the analog voltage signal to be transmitted to the first and second stages of the high pass filter to set: a DC bias for the first stage, and a DC bias for the second stage. The DAC can include: a first DAC coupled to and between the first stage and the adaptive averaging filter, and a second DAC coupled to and between the second stage and the adaptive averaging filter, the first DAC configured to convert the fifth digital signal waveform to a first analog voltage signal; and a second DAC coupled to and between the first stage of the high pass filter and the adaptive averaging filter, the second DAC configured to convert the fifth digital signal waveform to a second analog voltage signal. The logic circuitry may be further configured to: cause the first analog voltage signal to be transmitted to the second stage to set a DC bias for the second stage; and cause the second analog voltage signal to be transmitted to the first stage to set a DC bias for the first stage. The logic circuitry may be further configured to: determine an amplitude of the second digital signal waveform; and generate an analog voltage signal representative of the determined amplitude.

The high pass filter may include a first stage and a second stage, where the logic circuitry may be further configured to cause the signal to be transmitted to the second stage to set a gain of the second stage according to the analog voltage signal. The electronic circuit may also include a variable resistor coupled to the second stage, where to cause the signal to be transmitted to the second stage, the logic circuitry may be configured to cause the signal to be transmitted to the second stage. The signal being transmitted to the second stage may set the gain of the second stage by adjusting or maintaining a resistance value of the variable resistor according to the analog voltage signal. The signal being transmitted to the second stage may set the gain of the second stage by adjusting or maintaining the resistance value to the determined amplitude of the second digital signal waveform.

To convert the commutation current to the voltage signal waveform using the high pass filter, the high pass filter may be further configured to convert the commutation current to the voltage signal waveform in the absence of any discrete capacitor components. To convert the commutation current to the voltage signal waveform using the high pass filter, the high pass filter may be further configured to convert the commutation current to the voltage signal waveform in the absence of any discrete inductor components. To convert the commutation current to the voltage signal waveform using the high pass filter, the high pass filter may be further configured to convert the commutation current to the voltage signal waveform in the absence of any discrete capacitor and inductor components. The logic circuitry may be further configured to cause an output signal encoding data representative of the determined position of the movable structure to be transmitted to a subsystem for use thereby. The logic circuitry may be further configured to identify a fault condition of at least one of: the BDCM, and a BDCM-associated system.

The logic circuitry may be further configured to cause, in response to the fault condition being identified, an output signal indicating the presence of the fault condition to a user of the at least one of: the BDCM, and a BDCM-associated system. To identify the fault condition, the logic circuitry may be configured to identify the fault condition based at least in part on a departure of the wave count of the ripple waveform from an expected wave count value or range of values. To identify the fault condition, the logic circuitry may be configured to identify the fault condition based at least in part on a property of, or data derived by or encoded from, the fifth digital signal waveform.

### Example 3

A third example according to the present technology provides one or more non-transitory computer readable media (NT-CRM) having stored thereon program instructions which when executed by at least one processor, cause a machine to: isolate ripple waveform from a current signal originating from a BDCM; determine a wave count of the ripple waveform; and determine a position of a movable structure operably coupled to a shaft of the BDCM according to the wave count of the ripple waveform. The program instructions may further cause the machine to receive the current signal as a commutation current signal originating at brushes of the BDCM, and the machine may include a high pass filter configured to convert the commutation current signal to a voltage signal waveform. The machine may further include a first ADC coupled to the high pass filter and configured to convert the voltage signal waveform to a first digital signal waveform, where when executed by the processor(s), the program instructions can further cause the machine to filter, using a bandpass filter coupled to the first ADC, the first digital signal waveform to provide a second digital signal waveform. The machine may further include a memory storage device coupled to the processor(s), where when executed by the processor(s), the program instructions may further cause the machine to set high and low frequency cutoffs of the bandpass filter according to an expected frequency of the commutation current signal stored in the memory storage device.

When executed by the processor(s) to determine the wave count of the ripple waveform, the program instructions may further cause the machine to estimate a frequency of the second digital signal waveform. When executed by the processor(s), the program instructions may further cause the machine to adjust the high and low frequency cutoffs of the bandpass filter according to at least the estimated frequency of the second digital signal waveform. The machine may further include a comparator coupled to the bandpass filter, where when executed by the processor(s) to estimate the frequency of the second digital signal waveform, the program instructions may further cause the machine to transform, using the comparator, the second digital signal waveform to a third digital signal waveform having a fully positive polarity to facilitate counting of both rising and falling peaks of the ripple waveform as represented by the second digital signal waveform. When executed by the processor(s), the program instructions can further cause the machine to cause the third digital signal waveform to be transmitted to the bandpass filter to adjust the high and low frequency cutoffs of the bandpass filter according to at least the estimated frequency of the second digital signal waveform.

When executed by the processor(s) to determine the position of the movable structure, the program instructions may further cause the machine to: count the number of peaks of the third digital signal waveform over a period of time the shaft rotates; and compute a number of rotations of the shaft made in the period of time according to: the counted number of peaks, and a number of poles of the BDCM. When executed by the processor(s) to determine the position of the movable structure, the program instructions may further cause the machine to compute a linear distance traveled by the movable structure further according to known gear train information for one or more gears operably coupled to and between the shaft and the movable structure. When executed by the processor(s), the program instructions may further cause the machine to determine a direction of rotation of the shaft according to a polarity of the commutation current signal or a signal encoding data representative of the polarity of the commutation current signal. When executed by the processor(s) to determine the position of the movable structure, the program instructions may further cause the machine to compute a direction of the linear distance traveled by the movable structure according to the direction of rotation of the shaft.

The high pass filter can include a first stage and a second stage, and the machine can also include: an adaptive averaging filter, and a second ADC coupled to and between the first stage and the adaptive averaging filter, where the second ADC can be configured to convert an analog output signal of the first stage to a fourth digital signal waveform, and where when executed by the processor(s), the program instructions may further cause the machine to cause the third and the fourth digital signal waveforms to be transmitted to the adaptive averaging filter. When executed by the processor(s), the program instructions may further cause the machine to generate, using the adaptive averaging filter, a fifth digital signal waveform representative of an average amplitude of the third and fourth digital signal waveforms. The machine may further include a DAC coupled to and between the adaptive averaging filter and the high pass filter, where the DAC can be configured to convert the fifth digital signal waveform to an analog voltage signal, and where when executed by the processor(s), the program instructions may further cause the machine to cause the analog voltage signal to be transmitted to the first and second stages of the high pass filter to set: a DC bias of the first stage, and a DC bias of the second stage. The DAC can include: a first DAC coupled to and between the first stage and the adaptive averaging filter, and a second DAC coupled to and between the second stage and the adaptive averaging filter, where the first DAC can be configured to convert the fifth digital signal waveform to a first analog voltage signal, and a second DAC coupled to and between the first stage of the high pass filter and the adaptive averaging filter, where the second DAC can be configured to convert the fifth digital signal waveform to a second analog voltage signal, and where when executed by the processor (s), the program instructions may further cause the machine to: cause the first analog voltage signal to be transmitted to the second stage to set a DC bias for of the second stage; and cause the second analog voltage signal to be transmitted to the first stage to set a DC bias for of the first stage.

When executed by the processor(s), the program instructions may further cause the machine: determine an amplitude of the second digital signal waveform; and generate an analog voltage signal representative of the determined amplitude. The high pass filter may include a first stage and a second stage, where when executed by the processor(s), the program instructions may further cause the machine to cause the signal to be transmitted to the second stage to set a gain of the second stage according to the analog voltage signal. The machine can further include a variable resistor coupled to the second stage, where when executed by the processor(s) to cause the signal to be transmitted to the second stage, the program instructions may cause the machine to cause the signal to be transmitted to the second stage. The signal being transmitted to the second stage may set the gain for the second stage by adjusting or maintaining a resistance value of the variable resistor according to the analog voltage signal. The signal being transmitted to the second stage may set the gain for the second stage by adjusting or maintaining the resistance value to the determined amplitude of the second digital signal waveform.

When executed by the processor(s), the program instructions may further cause the machine to cause an output signal encoding data representative of the determined position of the movable structure to be transmitted to a subsystem for use thereby. When executed by the processor(s), the program instructions may further cause the machine to identify a fault condition of at least one of: the BDCM, and a BDCM-associated system. When executed by the processor(s), the program instructions may further cause the machine to cause, in response to the fault condition being identified, an output signal indicating the presence of the fault condition to a user of the at least one of: the BDCM, and a BDCM-associated system. When executed by the processor(s) to identify the fault condition, the program instructions can cause the machine to identify the fault condition based at least in part on a departure of the wave count of the ripple waveform from an expected wave count value or range of values. When executed by the processor(s) to identify the fault condition, the program instructions may cause the machine to identify the fault condition based at least in part on a property of, or data derived by or encoded from, the fifth digital signal waveform.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the foregoing discussion, the term “couple” or “couples” is intended to mean either an indirect or direct connection. Thus, if a first device couples to a second device, that connection may be through a direct connection or through an indirect connection via other devices and connections. Similarly, a device that is coupled between a first component or location and a second component or location may be through a direct connection or through an indirect connection via other devices and connections. Additionally, uses of the phrases “ground” or similar in the foregoing discussion are intended to include a chassis ground, an Earth ground, a floating ground, a virtual ground, a digital ground, a common ground, and/or any other form of ground connection applicable to, or suitable for, the teachings of the present disclosure. Unless otherwise stated, “about,” “approximately,” or “substantially” preceding a value means±10 percent of the stated value.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method comprising:
isolating a ripple waveform from a current signal originating from a brushed direct current motor (BDCM);
determining a wave count of the ripple waveform; and
determining a position of a movable structure operably coupled to a shaft of the BDCM according to the wave count of the ripple waveform.

2. The method of claim 1 further comprising:
receiving the current signal as a commutation current signal originating at brushes of the BDCM; and
converting the commutation current signal to an analog voltage signal waveform using a high pass filter.

3. The method of claim 2, wherein converting the commutation current signal comprises converting the analog voltage signal waveform to a first digital signal waveform, the method further comprising filtering the first digital signal waveform using a bandpass filter to provide a second digital signal waveform, the bandpass filter having high and low frequency cutoffs set according to an expected frequency of the commutation current signal.

4. The method of claim 3, wherein determining the wave count of the ripple waveform comprises estimating a frequency of the second digital signal waveform.

5. The method of claim 4, wherein estimating the frequency of the second digital signal waveform comprises transforming, using a comparator, the second digital signal waveform to a third digital signal waveform having a fully positive polarity to facilitate counting of peaks of the ripple waveform as represented by the second digital signal waveform.

6. The method of claim 5 further comprising:
converting an analog output signal of a first stage of the high pass filter to a fourth digital signal waveform; and
transmitting the third and the fourth digital signal waveforms to an adaptive averaging filter.

7. The method of claim 6 further comprising generating, by the adaptive averaging filter, a fifth digital signal waveform representative of an average amplitude of the third and fourth digital signal waveforms.

8. The method of claim 7 further comprising:
converting the fifth digital signal waveform to an analog voltage signal; and
transmitting the analog voltage signal to the first, and a second stage, of the high pass filter to set a DC bias for the first and second stages.

9. The method of claim 2, wherein the high pass filter lacks discrete capacitor components.

10. An electronic circuit comprising:
at least one input port configured to receive input signals, the input signals including a current signal originating from a brushed direct current motor (BDCM);
logic circuitry coupled to the at least one input port and configured to:
isolate a ripple waveform from the current signal;
determine a wave count of the ripple waveform; and
determine a position of a movable structure operably coupled to a shaft of the BDCM according to the wave count of the ripple waveform; and
at least one output port coupled to the logic circuitry and configured to transmit one or more output signals, the one or more output signals including data representative of the position of the movable structure determined by the logic circuitry.

11. The electronic circuit of claim 10, wherein the at least one input port is further configured to receive the current signal as a commutation current originating at brushes of the BDCM, the electronic circuit further comprising a high pass filter coupled to the at least one input port and configured to convert the commutation current to a voltage signal waveform.

12. The electronic circuit of claim 11, wherein the logic circuitry is further configured to:
determine an amplitude of a second digital signal waveform; and
generate a signal representative of the determined amplitude.

13. The electronic circuit of claim 12, wherein the logic circuitry is further configured to:
transmit a signal to a second stage of the high pass filter; and
set a gain of the second stage according to the signal.

14. The electronic circuit of claim 11, wherein the high pass filter is further configured to convert the commutation current to the voltage signal waveform without discrete inductor components.

15. The electronic circuit of claim 10, wherein the logic circuitry is further configured to transmit an output signal encoding data representative of the determined position of the movable structure to a subsystem for use thereby.

16. The electronic circuit of claim 10, wherein the logic circuitry is further configured to identify a fault condition of at least one of: the BDCM, and a BDCM-associated system.

17. The electronic circuit of claim 16, wherein the logic circuitry is further configured to transmit, in response to identifying the fault condition, an output signal indicating a presence of the fault condition to a user of the at least one of: the BDCM, and a BDCM-associated system.

18. One or more non-transitory computer readable media having stored thereon program instructions which when executed by at least one processor, cause a machine to:
isolate ripple waveform from a current signal originating from a brushed direct current motor (BDCM);
determine a wave count of the ripple waveform; and
determine a position of a movable structure operably coupled to a shaft of the BDCM according to the wave count of the ripple waveform.

19. The one or more non-transitory computer readable media of claim 18, wherein the machine includes a high pass filter configured to convert the current signal to a voltage signal waveform into a first digital signal waveform, and wherein, when executed by the at least one processor, the program instructions further cause the machine to filter the first digital signal waveform to a second digital signal waveform using a bandpass filter having high and low frequency cutoffs set according to an expected frequency of the current signal.

20. The one or more non-transitory computer readable media of claim 18, wherein, when executed by the at least one processor, the program instructions further cause the machine to transmit at least one of:
an output signal encoding data representative of the determined position of the movable structure; and
an output signal indicating a presence of a fault condition.
